(19) United States
(12) Patent Application Publication
(10) Pub. No.: US 2008/0136647 A1
(43) Pub. Date: Jun. 12, 2008

(54) PERSONAL RFID DETECTOR

(75) Inventor: Patrick Brown, Holbrook, NY (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: SYMBOL TECHNOLOGIES, INC., Holtsville, NY (US)

(21) Appl. No.: 11/609,106

(22) Filed: Dec. 11, 2006

(51) Int. Cl. G08B 13/14

(52) U.S. Cl. 340/572.8; 340/572.1

(57) ABSTRACT

A portable RFID detector that can be configured to scan an object and determine whether an RFID chip is included within or on the object is provided. Thee portable RFID detector can be utilized as a personal device allowing an individual to scan any number of objects for RFID chips. An indication of the presence or absence of an RFID chip can be presented to the user in any combination or sub-combination of a visual signal, an audible signal, vibratory signal, or other signal perceivable by a user. The portable RFID detector can be selectively activated and/or deactivated depending on the device configuration. The portable RFID detector can have a small footprint allowing the detector to be easily carried, such as in a pocket, on a key chain, or through various other means.

### TECHNICAL FIELD

The following description relates generally to radio frequency identification tag detection, and more specifically to personal detection of radio frequency identification tags.

### BACKGROUND

Radio frequency identification (RFID) tags are objects that identify various items by utilizing radio waves. RFID tags can be active tags that require an internal power source or passive tags that do not require an internal power source. Active tags have a larger range than passive tags. Radio frequency identification tags can be placed in various consumer products (e.g., clothing, pharmaceutical items, food boxes, or other products) to control inventory and, in some instances, as an attempt to prevent theft of such items. RFID tags can be used to capture ongoing information about a product.

RFID tags that are attached to a product can remain functional after purchase, thus, there can be some concern that they can be used for obtaining information for purposes that are not related to tracking the product for inventory or to reduce theft. As such, the tag can be read (sometimes at a distance) without the knowledge of the individual in possession of the product. This becomes more of a concern because the consumer might not be aware of the presence of the tag. The tagged product may be purchased with a form of payment that can be tracked to an individual (e.g., credit card, debit card, and the like) or purchased in conjunction with another identifying means (e.g., frequent customer card, loyalty card, discount card, and so forth). It is possible to link the identification of the item (e.g., through the RFID tag) to the identity of the purchaser. Some individuals may desire to detect the presence of such tags and remove the tags after purchase of a product for personal security as well as other reasons.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with a personal RFID detector. The personal detector has a small footprint and is lightweight to allow an easy transport by the user. The detector may be powered by a low-power battery to allow only the area or object of interest to be detected by the device, mitigating false readings. A light, sound or other technique can be utilized to indicate the presence of an RFID tag hidden in a product or otherwise not easily perceivable. For example, as the RFID tag gests closer, a cadence of an audio signal, can increase, a light source flicker speed can increase and/or a vibration of the device can increase.

Another embodiment relates to a personal RFID detector. The detector includes a housing that has a small footprint to allow for portability. Included in the housing can be an RFID detection component, an output component, and a power source. The RFID detection component can detect the presence of an RFID chip on a remote object. The output component can provide a perceivable notification of the presence of the RFID chip. The power source provides power to the RFID component and the output component.

Yet another embodiment relates to a method for providing a portable RFID detector. The method can include providing an RFID detection component internal to a device housing. The RFID detection component can be configured to detect the presence of an RFID tag on a remote product. The method can further include positioning one or more output components internal to the device housing so that an output indicative of the presence of an RFID tag is perceivable by a user.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates personal RFID detection system in accordance with the disclosed embodiments.

FIG. 2 illustrates another personal RFID detection system in accordance with the one or more embodiments.

FIG. 3 illustrates another personal RFID detector in accordance with the disclosed embodiments.

FIG. 4 illustrates a block diagram of a portable personal RFID detection system.

FIG. 5 illustrates an exemplary personal RFID device utilized as a key chain fob.

FIG. 6 illustrates an exemplary mechanical isometric of a personal RFID chip detector.

FIG. 7 illustrates a method for providing a personal RFID chip detector.

FIG. 8 illustrates a method for selectively determining the presence or absence of an RFID chip.

### DETAILED DESCRIPTION

Various embodiments are described with reference to the drawings. Throughout this description, like reference numerals refer to like elements. For purposes of explanation, numerous specific details are set forth in order to provide a thorough understanding of one or more aspects. However, the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. The word “exemplary” is used herein to mean serving as an example, instance, or illustration. Any aspect or design described herein as “exemplary” is not necessarily to be construed as preferred or advantageous over other aspects or designs.

One or more embodiments may be implemented as a method, apparatus, or article of manufacture using standard programming and/or engineering techniques to produce software, firmware, hardware, or any combination thereof to control a computer to implement the disclosed embodiments. Those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used.

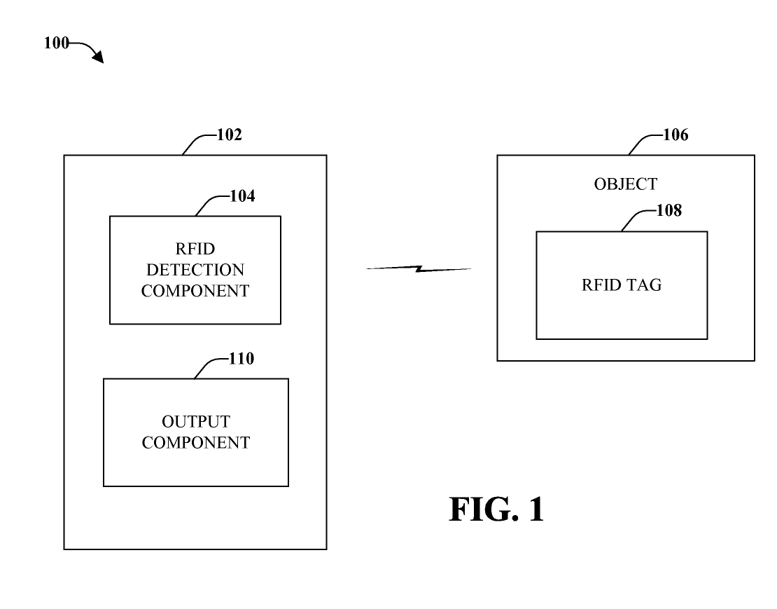

Referring initially to FIG. 1, illustrated is a personal RFID detection system 100 in accordance with the disclosed embodiments. The system 100 can be configured to allow an individual to determine whether an object has an RFID tag or chip. System 100 allows a user to maintain a sense of security by being able to determine which items or objects have an RFID tag. The user can selectively decide whether the RFID chip will be removed from the object based on knowledge of the location and existence of the RFID tag.

A personal RFID detector 102 is a compact device that can easily be transported by an individual. Therefore, detector 102 should have a small footprint and the weight of the detector 102 should be maintained as lightweight as possible. For example, RFID detector 102 can be small enough to hang on a key chain (e.g., a keychain fob) and carried along with the keys. In such a manner, the user can activate the detector 102 to detect the presence of an RFID tag while the user is on the move. For example, the user may purchase an item or may be given free products, such as promotional items. Once the item is in the user's possession, the user may desire to know if the product contains one or more RFID tags. Thus, utilizing the detector 102, the product can be immediately scanned the tag(s) removed or other action taken.

RFID detector 102 may include a RFID detection component 104 that can be configured to scan a remote object 106 and detect the presence of an RFID tag 108. To maintain an RFID detector 102 with a small footprint, the detector 102 might only be able to scan object(s) 106 at a range of one or two inches (e.g., read range). That is to say, the detector 102 should be placed close to the object 106 in order to obtain an accurate scan. As such, the detector 102 can be a low-powered device that only scans the area of interest (e.g., object 106) or a sub-portion of the area of interest. Scanning only the area of interest may also mitigate false readings from nearby objects that are not intended to be scanned. In accordance with some embodiments, the detector 102 can be equipped with a larger scanning range, such as with a high-powered device. A larger range may increase the size and weight of the detector 102.

If the RFID detection component 104 detects the presence of an RFID tag 108, an output component 110 can be configured to alert the user to the presence of the tag 108. Additionally or alternatively, output component 110 can be configured to notify the user if an RFID tag 108 is not present. For example, an audible tone or signal can be heard if there is an RFID tag detected 108. In some embodiments, the output component 110 produces a light signal or other visual signal to alert the user of the presence of the tag 108. The output component 110, in accordance with some embodiments, can include a vibratory signal that can be configured to vibrate the RFID detector 102 to indicate the presence of a tag 108. A light signal or vibratory signal may be suitable for a user who is hearing impaired or if the detector 102 is operating in a noisy environment. In accordance with some embodiments, the light signal, audible signal, and/or vibratory signal can be used individually or in conjunction with one or more other signal.

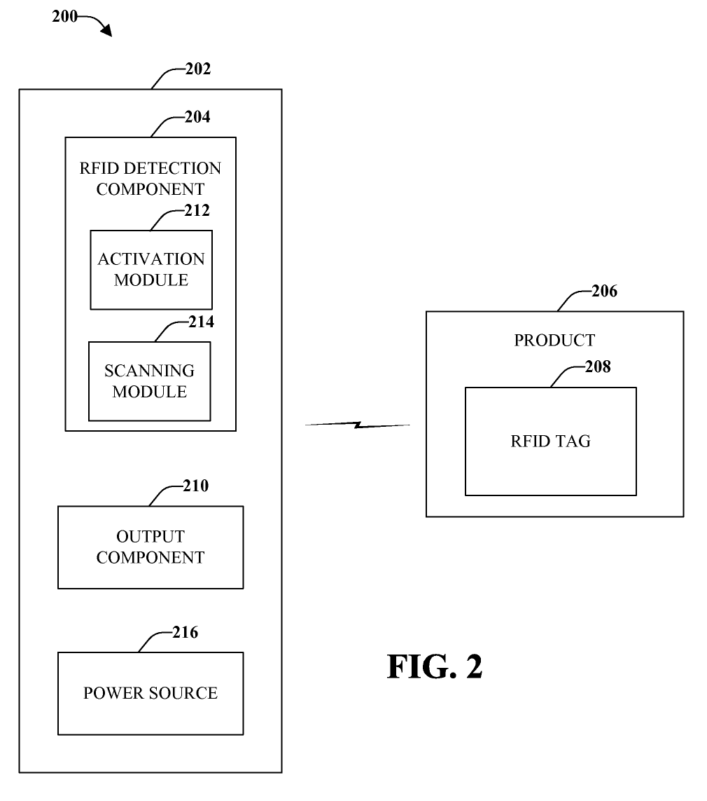

FIG. 2 illustrates another personal RFID detection system 200 in accordance with the one or more embodiments. Similar to the system shown and described above, system 200 can be portable whereby a user can easily transport the device and scan items as desired. For example, system 200 can be attached to a key ring or other item, or it can be configured to be worn on a finger, or the like.

An RFID detector 202 can be operated as a wand or another type of device that can be configured to be aimed at, passed over and/or brought within the vicinity of the remote object to be scanned. The RFID detector 202 can include a RFID detection component 204 that can be configured to scan a product 206 to determine whether there is an RFID tag 208 located on or within the product 206. The product 206 may include more than one RFID tag, however, only one tag 208 is illustrated for purposes of simplicity. If the presence of an RFID tag 208 is detected, an output component 210 can be configured to produce a signal or other means of notifying a user of the RFID detector 202 of the presence of the tag 208.

In further detail, detection component 204 can include an activation module 212 that can be configured to activate the detection system 200. Various means can be utilized to activate the detection system 200. The activation module 212 can be a button or switch whereby a user depresses the button (or turns the switch on) in order to scan the product 206. For example, a thumb switch can be provided, such that the switch can be conveniently and manually activated when the user wants the scan operation to be performed. In some embodiments, the activation module 212 can be activated based on an audio signal (e.g., voice command) or some other means of communicating that a product 206 is to be scanned. Alternatively or additionally, the activation module 212 can be automatically triggered to detect the presence of an RFID tag 208 when brought in close proximity. As such, the detector 202 would always be in an “active” or “on” mode and would not require a manual input from a user to activate the device to detect the presence of an RFID tag 208. In such embodiments, activation module 212 is constantly scanning and does not go into a “power down” mode. However, such constant scanning can waste resources (e.g., battery life) and may increase the size and weight of the RFID detector 202.

Also included in detection component 202 can be a scanning module 214 that can be configured to scan or detect the presence of an RFID tag 208. Scanning module 214 can be any type of scanner that can detect the presence of an RFID tag 208. For example, the scanning module 214 can comprise an RFID reader or other device that can detect the RFID tag 208. The scanning module 214 can utilize basic RFID technology, and can be repackaged in a specialized application using low power to locate the RFID tag or chip 208. The scanning module 214, in accordance with some embodiments, does not have to understand (or read) the information (e.g., serial number) contained in the RFID tag 208, but simply detects its presence. However, in accordance with some embodiments, the scanning module 214 can detect the presence of the tag and also can read the information included in the tag and output such information to the user, such as through output component 210 or though a display or user interface device.

A power source 216 can also be included to power various components of the RFID detector 202. Power source 216 can be any suitable means of providing power including, for example, one or more battery cells, connected in a configuration of the correct polarity to power the detector 202. It should be understood that any suitable battery chemistry can be utilized with the disclosed embodiments. In accordance with some embodiments, power source 216 is rechargeable, increasing the power-life of the detector 202. In some embodiments, power source 216 can be replaced or switched with a new power source on an as needed basis.

Optionally, a battery memory (not shown) may be incorporated into the detector 202 to retain data unique to the detector or the scanned RFID tags. The battery memory can be a non-volatile memory having a communication port for receiving power and signals from a processor of the scanner module 214 and/or for read/write of data back from/to the processor. Stored data can include battery type, battery pack type, model number, manufacturer, characteristics, discharge rate, predicted remaining capacity. In some embodiments, detector 202 includes an almost-discharged alarm so that a device processor can produce shutdown alerts to any combination of the light source, audio source, or vibratory source to warn the user of the low power and shut the detector 202 down gracefully to allow the user to recharge or change the power source 216.

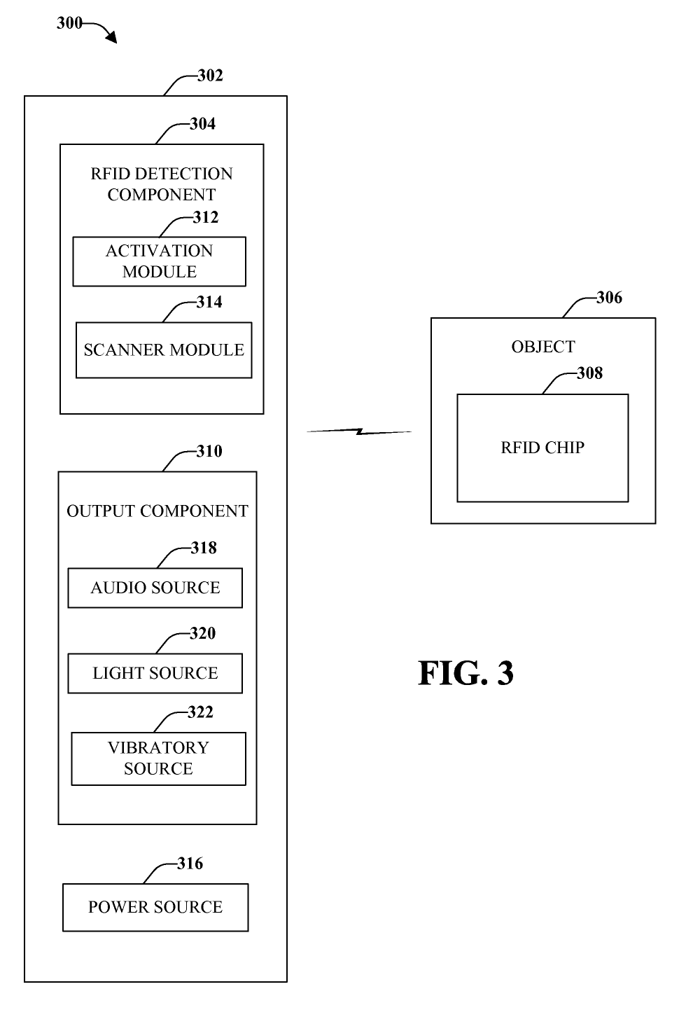

With reference now to FIG. 3 illustrated is another personal RFID detector system 300 in accordance with the disclosed embodiments. A personal RFID detector device is provided that includes a housing or case 302 configured to contain internal components. The housing can be 302 made of lightweight material and may be sealed to provide watertight conditions. The housing 302 may be constructed in such a manner that a user can access internal components to facilitate removal and replacement of such components. In other embodiments, the housing 302 may be constructed so that the internal components are not accessible by a user.

Internal to the housing is an RFID detection component 304 that may be configured to scan an object 306 to determine if an RFID chip 308 is incorporated on or within the object 306. Depending on the configuration, an output component 310 can provide various means of altering the user as to the presence or absence of an RFID chip 308. Further information regarding altering the user will be provided below. The RFID detection component 304 can include an activation module 312 and a scanner module 314, similar in operation to the activation mode 212 and scanner module 214 discussed above. In addition, internal to housing is a power source 316 similar to the power source 216 discussed above.

The output component 310 can include an audio source 318 that emits an audio signal corresponding to the scan status (e.g., RFID chip presence). If the scan of the object 306 detects an RFID chip 308, the audio source 318 may be configured to emit a high-pitched beep or tone. The beep or tone can be continuous until deactivated by a user, or for a predetermined amount of time (e.g., for 2 seconds after detecting a chip). In some embodiments, the beep or tone can be periodic or pulsating such that an interval of noise (e.g., beep) is alternated with an interval of silence. Alternatively, if the scan did not detect the presence of an RFID chip 308, the audio source 318 can be configured to emit a lower-pitched tone or beep. However, it should be understood that other configurations of producing an audible indication of the presence or absence of an RFID chip 308 can be utilized in conjunction with the disclosed embodiments. For example, the audio source 318 can emit a sound if there is an RFID chip 308 scanned while producing no sound if there was no RFID chip 308 scanned.

Alternatively or additionally, a light source 320 can be configured to alert the user whether an RFID chip 308 is scanned or detected. The light source 320 can comprise, for example, a Light Emitting Diode (LED) that can be configured to illuminate if an RFID chip 308 is detected. Alternatively or additionally, the LED can blink on and off upon detection. In accordance with some embodiments, a pair of LEDs are provided, each LED being a different color, wherein each color is associated with a particular status of the scanning operation for detection of an RFID chip 308. For example, the user may perceive a light of a first color when an RFID tag is detected (e.g., when a successful scan has occurred). If there is no RFID tag detected (e.g., the scan is unsuccessful), the user may perceive a light of a second color. It is to be appreciated that any suitable color scheme may be employed in connection with the light source(s) or LEDs and, further any suitable number of light source(s) may be employed in connection with the personal RFID detector.

An vibratory source 322 can be provided as an output to indicate the presence or absence of an RFID chip 308. The vibratory source 322 can be configured to vibrate or pulsate if a scan operation indicates the presence of a chip 308. However, in accordance with some embodiments, the vibratory source 322 can cause the RFID detector to vibrate during the scan operation and, if an RFID chip 308 is detected, the vibration may be discontinued. Thus, if there is no RFID chip 308 detected, the RFID detector would continue to vibrate until the scanning operation is discontinued, such as by manually turning “off” the detector or after a predetermined amount of time.

The controlled confirmations provided by the audio source 318, light source 320, and/or vibratory source 322 can be activated in various combinations or singularly. For example, normal operation may produce a steady light of a first color, while detection of an RFID chip 308 maintains the first colored light, and at substantially the same time activates a high beep from the audio source and causes the vibratory source to vibrate the detector. If an RFID chip 308 is not detected it may cause deactivation of the first colored light, activation of the light of the second color, and activation of the audio source to a produce a low beep. Obviously, both LEDs could be off during normal operation to provide the most efficient power savings, while either detecting or not detecting an RFID chip 308 produces activation of only one LED.

Furthermore, pulsing of the LEDs to produce more complex flashed alerting schemes can be utilized along with more tonal frequencies. An independent series of same frequency tones or a combination of multi-frequency tones can be used to indicate a different status of either the scanning operation, or transmit operation, or virtually any operation to which a signal or status is to be associated. Of course, in more robust implementations, more LEDs can be utilized to provide corresponding functions. Additionally, the LEDs need not be separate devices, but can be a multi-color LED device in a single case (e.g., a red/green/blue device or bi-color red/green device), or a flasher LED that includes a built-in chip for controlling a flashing function according to the corresponding presence of an RFID chip. However, if the power source is from batteries, the light source, audio source, and/or vibratory source should be suitable for low power consumption.

It should be understood that an RFID detector can include any subset of output components 310. For example, the audio source 318 can be configured to emit an audible tone in conjunction with a light emitted by the light source 320 such that the user receives feedback from two or more sources (e.g., audio source 318, light source 320) to ensure that there is a positive reading or detection of an RFID chip 308 and that the scan is conducted properly. For example, a higher-pitched beep may be sounded in conjunction with a first color to indicate the presence of an RFID chip 308 scan, and a lower-pitched beep can be emitted in conjunction with a second color to indicate that there is no RFID chip 308 detected. Other combinations or sub-combinations of the output components 310 can be utilized in accordance with the various embodiments presented herein.

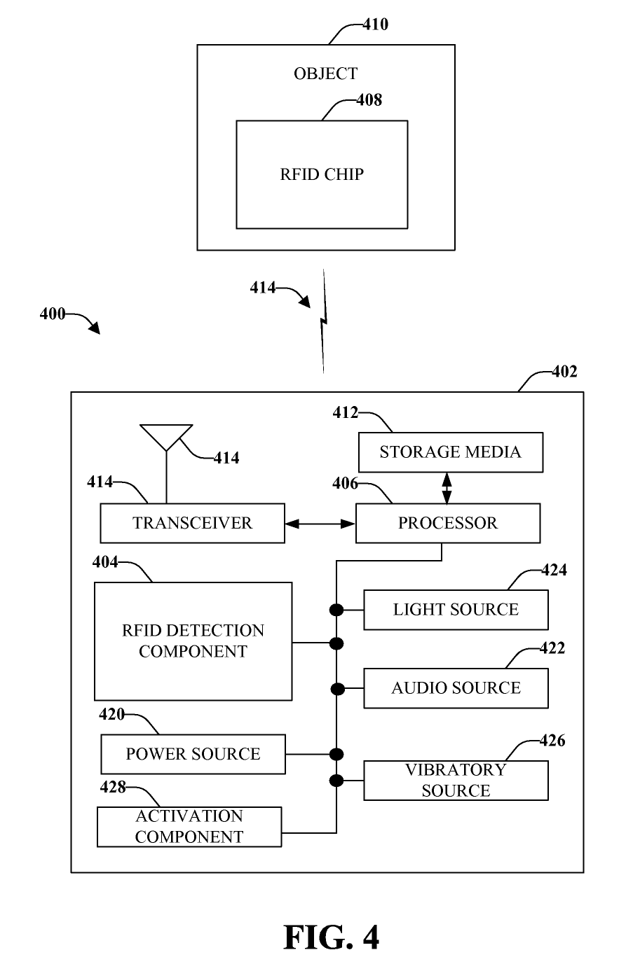

With reference now to FIG. 4, illustrated is a block diagram of a portable personal RFID detection device 400. The device 400 includes a housing or case 402 within which an RFID detection component 404 is located. The RFID detection component 404 may be any detecting or reading mechanism that can be configured for reading or detecting an RFID chip or tag on a remote product. In accordance with some embodiments, RFID detection component 404 does not read or decode the information included in an RFID tag. However, in accordance with other embodiments, the RFID detection component 404 reads information contained in an RFID tag and presents the result of the read operation to a user.

Also included in the housing 402 can be a processor 406 for controlling the onboard functions of the detection device 400 in order to detect an RFID chip 408 located on or within a target object 410. The processor 406 can be connected to the RFID detection component 404 to activate the reading function and/or detection function and receive information relating to the target object 410 and its inclusion of one or more RFID chip 408. Connected to the processor 406 can be a storage media 412 that can be configured to maintain various programs and other data associated with the operation of the RFID detection component 404.

A communication transceiver 414 connects to the processor 406 for communicating data and signals between the RFID detection component 404 and the RFID chip 410. The communication technology can be radio frequency (RF), therefore, an antenna 416 can be connected to the transceiver 414 to facilitate RF communication of signals and data wirelessly over a wireless link 418 established between the RFID chip 408, if any, and the RFID detection component 404. In some embodiments, wireless communication technologies can be utilized between the RFID detection component 404 and RFID chip 408. Further, the system 400 can be implemented in a wired regime such that the RFID detection component 404 and RFID tag 408 are connected in wired communication.

The housing 402 can also enclose a power source 420, an audio source 422, a light source 424 and/or a vibratory source 426 all of which are operably interconnected with the processor 406. Upon detection of one or more RFID chip 408, the RFID detection component 404 and/or processor 406 can activate one or more of the audio source 422, light source and vibratory source 426.

An activation component 428 can be included in the housing 402. Such activation component 428 can be configured to activate (e.g., turn “on”) the RFID detection component 404 in order to perform a scanning function. Various techniques can be utilized to activate and/or deactivate the personal RFID detection device 400. For example, a user can press a button that is operatively connected to activation component 428. At substantially the same time as pressing the button, the user can move the device 400 over an object 410. The activation component 428 and/or processor 406 can scan the object 410 in order for the RFID detection component 404 to detect the presence of an RFID chip 408. It should be understood that the various function of the device 400 can be controlled by separate components, as illustrated, or a single component can control multiple functions.

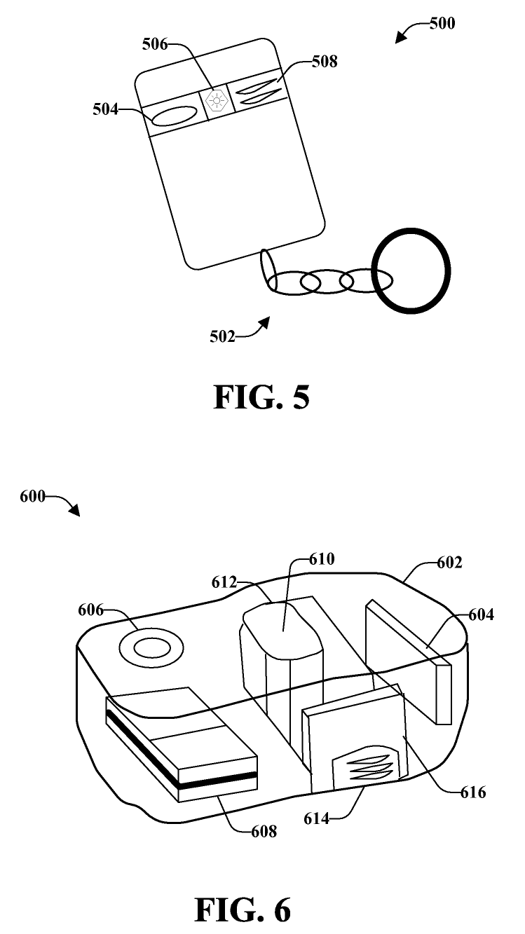

FIG. 5 illustrates an exemplary personal RFID device 500 utilized as a key chain fob. A personal RFID device 500 can be configured to allow an individual to easily carry the device 500 in a pocket or on a key chain 502, as illustrated. Alternatively or additionally, device 500 can employ other means for being easily carried. For example, device 500 can include a clip (not shown) allowing it to be attached to other objects (e.g., a purse, a belt buckle, and so forth). Device 500 may also be placed in a carrying case, slipped in to a pocket, or transported in a variety of other ways.

The device 500 can include a power button 504 which a user can press to active and/or deactivate the device. In accordance with some embodiments, the power button 504 can be pressed a first time to activate the device (e.g., place the device in an “on” state). After scanning the desired object, the power button 504 can be pressed a second time to deactivate the device 500 (e.g., place the device in an “off” state). In some embodiments, the device 500 is in an active state while the power button 504 is being pressed. When the user releases the power button 504, the device power is deactivated. In such a manner, the device 500 remains in an “off” state and is only placed into an “on” state while the power button 504 is being pressed, mitigating the changes of the user forgetting to turn off the power (e.g., by pressing the button a second time) and draining a power supply contained in the device 500.

Also included is a light source 506, such as an LED. The LED can be any color and there can be more than one LED, depending on the device 500 configuration. As illustrated, the light source 506 is viewable external to a device housing. In accordance with some embodiments, the LED is activated (e.g., illuminates) while the power is applied to the device 500 (e.g., while in an “on” state). As the device 500 is brought closer to an RFID chip, the LED can flash or indicate in some other way that there is an RFID chip detected. In some embodiments, the LED flashes while the device 500 is in an “on” state and blinks on and off at a faster rate as the device 500 is moved closer to the RFID chip until the LED stops blinking and steadily illuminates indicating that the RFID chip and device are in close proximity, thus, indicating the distance between the device 500 and the RFID chip. If an RFID chip is not detected, the LED can keep flashing and not produce a steady light.

Additionally or alternatively, a speaker 508 is included in device 500 to allow a user to perceive an audible tone. For example, the speaker 508 can project a tone that increases in frequency and/or cadence as an RFID chip is approached. When the RFID is closest to the device 500, the tone can remain constant. It should be understood that any combination or sub-combination of visual means and/or audible means can be employed with the disclosed embodiments, including other notification means (e.g., vibratory source).

FIG. 6 illustrates an exemplary mechanical isometric of a personal RFID chip detector 600. It should be understood that the various personal RFID chip detectors illustrated and described herein are for example purposes only and many different configurations are possible with the one or more disclosed embodiments.

A housing 602 contains the various components of the chip detector 600. The housing 602 can be made of any suitable material and should be sealed to prevent water from entering the housing 602 and damaging the internal components. In some embodiments, the chip detector 600 will be placed on a key chain or other item for ease of carrying. Thus, if it is raining outside or the chip detector 600 is dropped into a puddle, the housing 602 should have a watertight sealing to prevent damage to the internal components.

Contained within the housing 602 is an RFID scanner 604 that can be configured to detect the presence of an RFID chip when the device is brought within proximity of an object. A user interface 606 (e.g., button, switch, and the like) can be placed on the housing 602 to allow the user to activate the chip detector 600. For example, the user may depress a button when the user would like to know if an object contains an RFID chip. In accordance with some embodiments, a user interface 606 is not provided, and the detector 600 is automatically triggered to detect the presence of an RFID tag when brought in close proximity to an RFID tag.

Also included within the housing is a power source 608, such as a battery or other energy source. In some embodiments, more than one battery 608 can be utilized. The battery 608 should be placed in an appropriate polarity configuration to interact with an electrical interface. In addition, any suitable battery chemistry can be utilized.

Within the housing 602 is also a light source 610 that illuminates a light signal corresponding to the presence or absence of an RFID chip. The light source 610 can comprise one or more LED element, for example. The light source(s) 610 can be placed in alignment with a view port 612 to allow the user to perceive when the light source 610 is illuminated. In some embodiments, the light source 610 is positioned within the housing 602 in such a manner that the light source 610 is viewable external to the housing 602 and a view port 612 is not needed. The light source 610 should be positioned to allow it to be visible from most angles in which the user's hand may be oriented during use of the chip detector 600. The light source 610 should also be positioned to mitigate breakage or other damage. Additionally or alternatively, included is an audio source 614 positioned to emit an audio signal so that the user can perceive the audio signal. In some embodiments, a vibratory source 616 is included to vibrate the chip detector 600 in accordance with the presence or absence of an RFID chip.

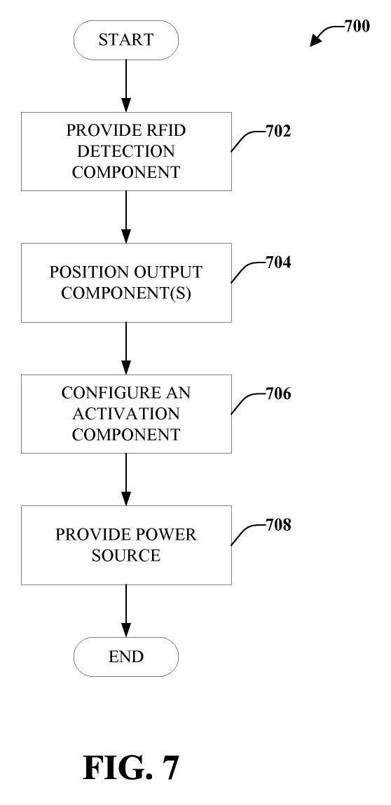

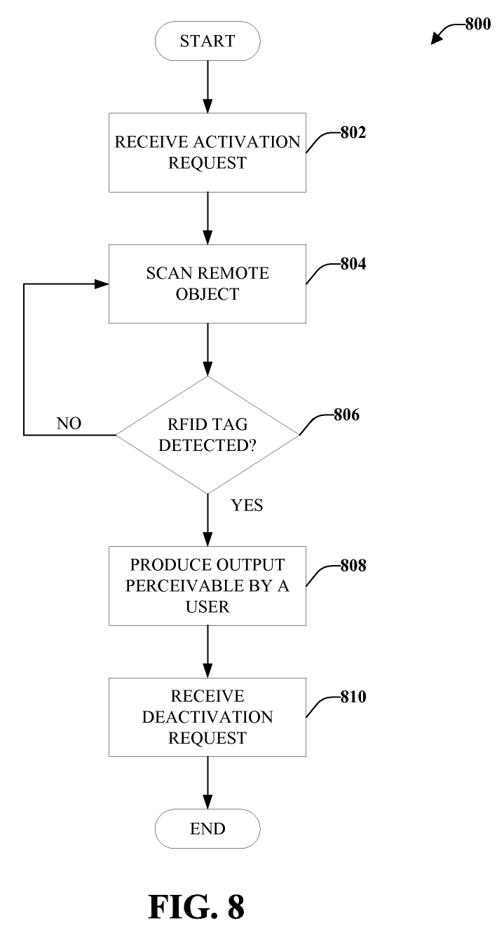

In view of the exemplary systems shown and described above, methodologies that may be implemented in accordance with the disclosed subject matter, will be better appreciated with reference to the flow charts of FIGS. 7-8. While, for purposes of simplicity of explanation, the methodologies are shown and described as a series of blocks, it is to be understood and appreciated that the claimed subject matter is not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 7 illustrates a method 700 for providing a personal RFID chip detector. Method 700 starts, at 702, where an RFID detection component is provided. The RFID detection component can be located or placed internal to a detector housing. The housing can be configured to be sealed, such that water cannot penetrate the housing (e.g., water tight). In some embodiments, the housing can be sealed without a way for a user to access components internal to the housing. In some embodiments, the housing is configured to allow a user access to the internal components, such as to replace and/or repair the internal components.

Method 700 continues, at 704, where one or more output components are positioned internal to the housing. The one or more output components should be positioned so that an output indicative of the presence or absence of an RFID chip can be perceived by a user. The one or more output components can be an audio source, a visual source, a vibratory source, or another source that can be perceived by a user. Therefore, a portion of the visual source (e.g., LED) can be placed external to the housing. The audio source may include a speaker or other means to allow the sound, tone, etc. to be heard external to the housing. The vibratory source may be configured so that a vibratory signal is perceivable external to the device housing. The various output components can be configured to provide a notification perceivable by the user and each output component can operate independently or in conjunction with one or more other output component.

At 706, an activation component is configured to selectively activate and/or deactivate the detector. For example, the activation component can be automatically activated when the detector is within close proximity to an RFID tag. In some embodiments, activation component activates the detector when a user input is received (e.g., turn “on” the detector). A second user input can deactivate the detector (e.g., turn “off” the detector). In some embodiments, the activation component activates the detector when a user input is received (e.g., pressing a button) and deactivates when the user input is removed (e.g., the button is no longer pressed).

Method 700 can further include providing a power source, at 708. The power source can provide any type of power, such as a low power battery. In some embodiments, the power source can be rechargeable, such as though a connector included in the housing. In some embodiments, the power source can be accessible though the housing and replaced by a user.

FIG. 8 illustrates a method 800 for selectively determining the presence or absence of an RFID chip. Method 800 starts, at 802, when an activation request is received. Such activation request can be a manual request from a user to activate the detector. Various types of user inputs can be received including pressing a button, toggling a switch, and so forth. The activation request can be received autonomously from the detector when it moved in close proximity to an RFID chip.

At 804, a remote object is scanned by an RFID detector. Such scanning can be performed to determine whether there is an RFID chip present on the remote object. In some embodiments, RFID detector can read information included in the RFID chip at substantially the same time as the object is scanned and the RFID chip is detected.

Method 800 continues, at 806, where a determination is made whether an RFID chip is present on the remote object. If there is no RFID chip detected (“NO”), method can continue, at 804, with continued scanning of the remote object. Alternatively, the scanning operation can be discontinued if an RFID chip is not detected.

If an RFID chip is detected, at 806, (“YES”), method 800 continues, at 808, where an output perceivable by a user is produced. The output can be any type of notification perceivable by a user (e.g., audio, visual, and so forth). The output can also be configured to indicate the absence of an RFID chip as a further user perceivable condition.

At 808, a request to deactivate the detector can be received. Such a request can include a user input, such as pressing a button, moving a switch, or other means of deactivating the detector. In some embodiments, the request to deactivate the detector is received from the detector autonomously when the detector is no longer in the proximity of an RFID chip. Any number of objects can be scanned to detect the presence or absence of an RFID chip in accordance with the disclosed embodiments.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A personal radio frequency identification (RFID) detector, comprising:
a housing that has a small footprint for portability;
an RFID detection component internal to the housing, the RFID detection component detects the presence of an RFID chip on a remote object;
an output component internal to the housing, the output component provides a perceivable notification of the presence of the RFID chip; and
a power source internal to the housing, the power source supplies power to the RFID detection component and the output component.

2. The personal RFID detector of claim 1, further comprising an activation component that selectively activates and deactivates the detector.

3. The personal RFID detector of claim 2, the activation component activates the detector when the detector is in close proximity of the RFID chip.

4. The personal RFID detector of claim 2, at least a portion of the activation component is accessible external to the housing.

5. The personal RFID detector of claim 4, the activation component activates the detector upon a first user input and deactivates the detector upon a second user input.

6. The personal RFID detector of claim 1, the output component is a light source that provides a light signal in response to the presence of the RFID chip.

7. The personal RFID detector of claim 1, the output component is an audio source that emits an audible signal in response to the presence of the RFID chip.

8. The personal RFID detector of claim 1 the output component is a vibratory source that produces a vibratory signal in response to the presence of the RFID chip.

9. The personal RFID detector of claim 1, the housing is sealed to provide a water-tight condition.

10. The personal RFID detector of claim 1, the housing is selectively attached to a key ring.

11. A method of providing a portable RFID device, comprising:
providing an RFID detection component internal to a device housing, the RFID detection component detects the presence of an RFID tag on a remote product; and
positioning at least one output component internal to the device housing so that an output indicative of the presence of the RFID tag is perceivable by a user.

12. The method of claim 11, further comprising:
providing a light source that emits a light signal indicative of the presence of the RFID tag; and
positioning the light source so that the light signal is viewable external to the device housing.

13. The method of claim 11, further comprising:
providing an audible source that produces an audible signal indicative of the presence of the RFID tag; and
positioning the audible source internal to the device housing so that the audible signal is perceivable external to the housing.

14. The method of claim 11, further comprising:
providing a vibratory source that produces a vibratory signal indicative to the presence of the RFID tag; and
configuring the vibratory source within the device housing so that the vibratory signal is perceivable external to the device housing.

15. The method of claim 11, further comprising:
placing an activation component internal to the device housing such that at least a portion of the activation component is accessible external to the device housing; and
configuring the activation component so that a first input activates the RFID detection component and a second input deactivates the RFID detection component.

16. The method of claim 11, further comprising:
positioning at least one power source internal to the device housing, such that the at least one power source is accessible through the device housing.

17. The method of claim 11, further comprising sealing the device housing to mitigate water penetration into the device housing.

18. A personal RFID detector, comprising:
means for activating the RFID detector;
means for scanning an object with the RFID detector;
means for detecting an RFID tag included in the scanned object;
means for communicating whether an RFID tag is included in the scanned object; and;
means for deactivating the RFID detector.

19. The personal RFID detector of claim 18, further comprising a means for supplying power to the RFID detector.

20. The personal RFID detector of claim 19, further comprising at least one of a means for providing a visual signal, means for emitting an audible signal and means for producing a vibratory signal if the RFID tag is including in the scanned object.
